(19) United States
(12) Patent Application Publication
(10) Pub. No.: US 2022/0320881 A1
(43) Pub. Date: Oct. 6, 2022

(54) BATTERY CHARGING MODULE, BATTERY REPLACEMENT DEVICE, AND BATTERY DEVICE

(71) Applicant: PANASONIC INTELLECTUAL PROPERTY MANAGEMENT CO., LTD., Osaka (JP)

(72) Inventors: Toshiya ZAITSU, Tokyo (JP); Masashi TAKEMURA, Kanagawa (JP); Ryota SAITO, Kanagawa (JP); Kenichiro SHIBASAKI, Kanagawa (JP)

(73) Assignee: PANASONIC INTELLECTUAL PROPERTY MANAGEMENT CO., LTD., Osaka (JP)

(21) Appl. No.: 17/638,550

(22) PCT Filed: Aug. 25, 2020
(86) PCT No.: PCT/JP2020/031998

§ 371 Date: Feb. 25, 2022

(30) Foreign Application Priority Data
Aug. 27, 2019 (JP) 2019-154710

(51) Int. Cl. H02J 7/00; H02J 50/10; B60L 53/80

(52) U.S. Cl. CPC H02J 7/0045; H02J 50/10; H02J 7/0049; H02J 7/005; H02J 7/00036; B60L 53/80

(57) ABSTRACT

Provided is a battery share system in which a necessary change in the scale of a battery exchange device can be made with ease and at low cost even after the start of operating a service, and the battery exchange device can be made simple without any features for rainwater resistance. A plurality of battery charging modules for holding a battery pack are attached to a support post to form a battery exchange device. A battery charging module is detachably attached to the support post, and includes a tray for guiding the battery pack to a predetermined mounting position and holding the battery pack at the mounting position. The tray includes a wireless power transmitter with a transmitter coil for contactless transmission of charging power to the battery pack, and a wireless communication device for contactless communications of battery management information with the battery pack.

### TECHNICAL FIELD

The present disclosure relates to a battery charging module, a battery exchange device, and a battery device, where the battery charging module is configured to hold the battery device, and where a plurality of the battery charging module are attached to a support to form a battery exchange device.

In recent years, electric vehicles such as electric motorcycles have been drawing attention from the viewpoint of providing solutions to the problems of air pollution due to exhaust gas and fuel cost. Driving ranges of such electric vehicles have extended due to the improvement in the performance of battery devices. However, there is still an inconvenience that the need of charging batteries prevents long-time continuous driving of an electric vehicle.

Known technical ideas to eliminate this inconvenience include a battery replacement service system configured such that an electric vehicle is provided with a detachable battery device, and that, in a battery station, a low remaining charge battery device can be replaced with a fully-charged battery device, thereby enabling long-time continuous driving of the electric vehicle.

The battery replacement service system may be configured such that a battery exchange device is installed at the battery station, and used to receive and accommodate a battery device which a user has brought in, and allows a charged battery device to be rented out to the user. In this case, since a battery device is usually relatively heavy, the system enables a user to easily swap batteries; that is, the system can reduce a burden on the user, thereby improving the user's convenience.

Known technologies to reduce a burden on users who need to swap batteries include a battery replacement device in which batteries are accommodated in an array or in a row and a battery located one end of the battery array/row projects frontward to make it easy for a user to pull out the battery (Patent Document 1), and a battery charging device in which a battery housing for accommodating batteries can be tilted frontward to make it easy for a user to set in and/or pull out a battery (Patent Document 2).
Patent Document 1: JP4479977B
Patent Document 2: JP2014-072951A

### SUMMARY OF THE INVENTION

### Task to be Accomplished by the Invention

Demand for battery replacement services vary depending on the location where a battery exchange device is installed. Thus, the scale or size of a battery exchange device used for replacement of batteries needs to be changed based on predicted demand level for a battery replacement service. However, in many cases, after the start of operating a battery replacement service, the predicted demand level turns out to be significantly different from actual usage of the battery replacement service. Thus, it often becomes necessary to adjust the scale or size of a battery exchange device after the start of operating the service.

In the above-described prior art disclosed in Patent Document 1, the scale of a device can be adjusted to an appropriate scale (size) for actual demand for the battery replacement service, by providing battery slots with covers to thereby change the number of available battery slots. In the above-described prior art disclosed in Patent Document 2, the scale of a battery charging device can be adjusted by changing the number of battery charging lockers to be connected to the device. However, these devices of the prior art involve a problem that, after the start of operating the service, it is not easy to change the scale of a battery exchange device at low cost.

Moreover, there is a need for simplification of the configuration of a battery exchange device in order to reduce installation cost. For example, in the case of a battery exchange device is configured such that a battery device is held in an externally exposed state, the battery exchange device can be made simple, compared to a device in which a battery device is held and enclosed within a housing. However, such a battery-exposing type configuration requires a rainwater resistance feature necessitated by the resulting structure in which a power transmitter terminal for transmitting charging power to the battery device and a communication terminal for transmitting battery management information acquired from the battery device are also externally exposed, and the requirement of such a rainwater resistance feature inconveniently makes it difficult to sufficiently simplify the configuration of a battery exchange device.

The present disclosure has been made in view of the problem of the prior art, and a primary object of the present disclosure is to provide a battery charging module, a battery exchange device, and a battery device, which ensure that a necessary change in the scale of a battery exchange device can be made with ease and at low cost even after the start of operating a service, and eliminate the need for any feature for rainwater resistance to thereby enable the battery exchange device to be made simple.

### Means to Accomplish the Task

An aspect of the present disclosure provides a battery charging module for holding a battery device, wherein the battery charging module is detachably attached to a support, and wherein a plurality of the battery charging module are attached to the support to form a battery exchange device, wherein the battery charging module comprises a tray for guiding a battery device to a predetermined mounting position and holding the battery device at the mounting position, wherein the tray comprises: a wireless power transmitter for transmitting charging power to the battery device in a non-contact manner; and a wireless communication device for transmitting and receiving battery management information to and from the battery device in a non-contact manner.

Another aspect of the present disclosure provides a battery exchange device, wherein a plurality of battery charging modules for holding a battery device are attached to a support to form the battery exchange device, wherein each of the battery charging modules is detachably attached to the support, and comprises a tray for guiding the battery device to a predetermined mounting position and holding the battery device at the mounting position, wherein the tray comprises: a wireless power transmitter for transmitting charging power to the battery device in a non-contact manner; and a wireless communication device for transmitting and receiving battery management information to and from the battery device in a non-contact manner, wherein either of the battery charging module or the support comprises: a locking member for preventing the battery device from being removed from the mounting position, and a driver for driving the locking member; and an indicator for indicating a state-of-charge of the battery device.

Yet another aspect of the present disclosure provides a battery device adapted to be held by the battery charging module, the battery device comprising a locking member for preventing the battery device from being removed from the mounting position, and a driver for driving the locking member.

### Effect of the Invention

According to the present disclosure, it is possible to easily increase or decrease the number of battery charging modules based on actual usage of a battery replacement service. As a result, even after the start of operating a service, a necessary change in the scale of a battery exchange device can be made with ease and at low cost. Furthermore, as wireless power transfer and wireless communication are used in a battery exchange device, a power transmitter terminal and a communication terminal are not externally exposed and thus any feature for rainwater resistance is not necessary, which enables the battery exchange device to be made simple.

### BRIEF DESCRIPTION OF THE DRAWINGS

FIG. 1 is a diagram showing a general configuration of a battery share system according to a first embodiment of the present disclosure;

FIG. 2 is a front view of a battery exchange apparatus 3 according to the first embodiment;

FIG. 3 is a side view of the battery exchange apparatus 3 according to the first embodiment;

FIG. 4 is an explanatory diagram showing attachment structures of battery charging modules 23 according to the first embodiment;

FIG. 5 is an explanatory diagram showing a locking mechanism 41 of the battery exchange apparatus 3 according to the first embodiment;

FIG. 6 is a block diagram showing schematic configurations of a battery pack 2 and a battery charging module 23 according to the first embodiment;

FIG. 7 is an explanatory diagram showing a guide structure for the battery pack 2 in a battery charging module 23 according to the first embodiment;

FIG. 8 is an explanatory diagram showing a locking mechanism 101 of the battery exchange apparatus 3 according to a first variant of the first embodiment;

FIG. 9 is an explanatory diagram showing a locking mechanism 111 of the battery exchange apparatus 3 according to a second variant of the first embodiment;

FIG. 10 is a front view of a battery exchange apparatus 201 according to a second embodiment of the present disclosure;

FIG. 11 is a plan view of the battery exchange apparatus 201 according to the second embodiment;

FIG. 12 is an explanatory diagram showing a locking mechanism 221 of the battery exchange apparatus 201 according to the second embodiment;

FIG. 13 is a front view of a battery exchange apparatus 301 according to a third embodiment of the present disclosure;

FIG. 14 is a side view of the battery exchange apparatus 301 according to the third embodiment;

FIG. 15 is a front view of a battery exchange apparatus 401 according to a fourth embodiment of the present disclosure;

FIG. 16 is a side view of the battery exchange apparatus 401 according to the fourth embodiment;

FIG. 17 is a front view of a battery exchange apparatus 501 according to a fifth embodiment of the present disclosure;

FIG. 18 is a side view of the battery exchange apparatus 501 according to the fifth embodiment;

FIG. 19 is a front view of a battery exchange apparatus 601 according to a sixth embodiment of the present disclosure;

FIG. 20 is a side view of the battery exchange apparatus 601 according to the sixth embodiment;

FIG. 21 is an explanatory diagram showing a battery pack 701 and a battery charging module 702 according to a seventh embodiment of the present disclosure; and

FIG. 22 is a block diagram showing schematic configurations of a battery pack 701 and a battery charging module 702 according to the seventh embodiment.

### DESCRIPTION OF THE PREFERRED EMBODIMENTS

A first aspect of the present disclosure made to achieve the above-described object is a battery charging module for holding a battery device, wherein the battery charging module is detachably attached to a support, and wherein a plurality of the battery charging module are attached to the support to form a battery exchange device, wherein the battery charging module comprises a tray for guiding a battery device to a predetermined mounting position and holding the battery device at the mounting position, wherein the tray comprises: a wireless power transmitter for transmitting charging power to the battery device in a non-contact manner; and a wireless communication device for transmitting and receiving battery management information to and from the battery device in a non-contact manner.

In this configuration, it is possible to easily increase or decrease the number of battery charging modules based on actual usage of a battery replacement service. As a result, even after the start of operating a service, a necessary change in the scale of a battery exchange device can be made with ease and at low cost. Furthermore, as wireless power transfer and wireless communication are used in a battery exchange device, a power transmitter terminal and a communication terminal are not externally exposed and thus any feature for rainwater resistance is not necessary, which enables the battery exchange device to be made simple.

A second aspect of the present disclosure is the battery charging module of the first aspect, wherein the wireless communication device performs wireless communications with the battery device utilizing wireless LAN communications, short-range wireless communications, or infrared communications.

In this configuration, the battery charging module can properly transmit and receive battery management information to and from a battery device. In this case, the wireless LAN communications may utilize Wi-Fi (registered trademark) communications, and the short-range communications may utilize Bluetooth (registered trademark) communications or RFID (Radio Frequency Identifier).

A third aspect of the present disclosure is the battery charging module of the first aspect, wherein the tray comprises an indicator for indicating a state-of-charge of the battery device.

In this configuration, a user can check the state-of-charge of each battery device mounted in a corresponding battery charging module.

A fourth aspect of the present disclosure is the battery charging module of the first aspect, wherein the tray comprises a locking member for preventing the battery device from being removed from the mounting position, and a driver for driving the locking member.

This configuration can prevent an incompletely-charged battery device from accidentally being rent out and prevent battery devices from falling and being damaged in an earthquake.

A fifth aspect of the present disclosure is the battery charging module of the first aspect, wherein the tray holds the battery device such that the battery device is in an inclined state in which a handle of the tray faces obliquely upward.

This configuration can reduce the vertical size (height) of each battery device mounted in the tray, thereby enabling the battery exchange device to accommodate more battery devices.

A sixth aspect of the present disclosure is the battery charging module of the first aspect, wherein the tray holds the battery device such that the battery device is in an upright state in which a handle of the tray faces upward.

This configuration can reduce the depth size of each battery device mounted in the tray, thereby minimizing the space the battery exchange device occupies.

A seventh aspect of the present disclosure is a battery exchange device, wherein a plurality of battery charging modules for holding a battery device are attached to a support to form the battery exchange device, wherein each of the battery charging modules is detachably attached to the support, and comprises a tray for guiding the battery device to a predetermined mounting position and holding the battery device at the mounting position, wherein the tray comprises: a wireless power transmitter for transmitting charging power to the battery device in a non-contact manner; and a wireless communication device for transmitting and receiving battery management information to and from the battery device in a non-contact manner, wherein either of the battery charging module or the support comprises: a locking member for preventing the battery device from being removed from the mounting position, and a driver for driving the locking member; and an indicator for indicating a state-of-charge of the battery device.

In the configuration, even after the start of operating a service, a necessary change in the scale of a battery exchange device can be made with ease and at low cost as in the first aspect. Furthermore, the configuration can prevent an incompletely-charged battery device from accidentally being rent out and prevent battery devices from falling and being damaged in an earthquake.

An eighth aspect of the present disclosure is the battery exchange device of the seventh aspect, wherein the support comprises the locking member and the driver, for each battery charging module.

In this configuration, it is possible to individually lock each battery device mounted on the battery charging module. Since the configuration eliminates the need for a battery charging module to include a locking mechanism, a configuration of a battery charging module can be simplified.

A ninth aspect of the present disclosure is the battery exchange device of the seventh aspect, wherein the battery charging module is rotatably attached to the support so that the battery charging module is rotatable about an axis in a substantially vertical direction.

In this configuration, a search for an empty battery charging module or a fully-charged battery device can be made by rotating the battery charging module. This eliminates the need for a user to walk around the battery exchange device, thereby improving the user's convenience.

A tenth aspect of the present disclosure is a battery device adapted to be held by the battery charging module, the battery device comprising a locking member for preventing the battery device from being removed from the mounting position, and a driver for driving the locking member.

This configuration can prevent an incompletely-charged battery device from accidentally being rent out and prevent battery devices from falling and being damaged in an earthquake. A locking member provided in the battery device may be adapted to be engaged with a support or with the battery charging module. In either case, the locking member can prevent the battery device from being removed.

Embodiments of the present disclosure will be described below with reference to the drawings.

### First Embodiment

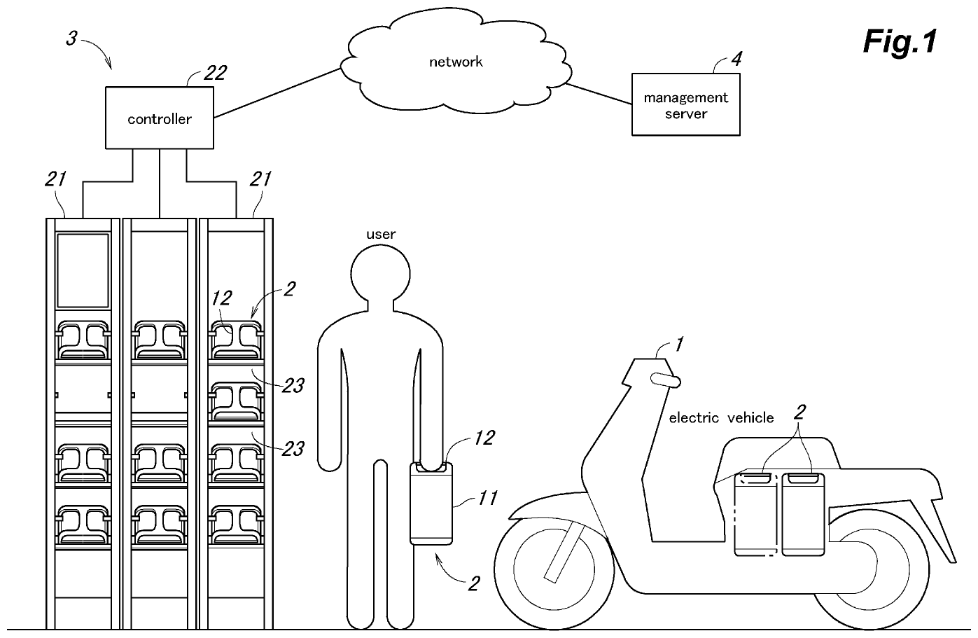

FIG. 1 is a diagram showing a general configuration of a battery share system according to a first embodiment of the present disclosure.

This battery share system provides a service (battery replacement service) which enables a plurality of users to share a battery pack 2 (battery device) to be mounted in an electric vehicle 1 such as an electric motorcycle, and the system includes a battery exchange apparatus 3 (battery exchange device) and a management server 4.

The electric vehicle 1 is equipped with a battery pack(s) 2 and runs on the electric power of the battery pack 2. In the example shown in FIG. 1, the electric vehicle 1 is an electric motorcycle, but the electric vehicle 1 may be a four-wheeled vehicle. In other cases, the electric vehicle 1 may be a mobility device that is generally not used on a driving lane, such as an electric wheelchair, an electric cart, or a passenger cart used in a theme park, a golf course, or other places.

A battery pack 2 includes a housing 11 and a handle 12 on the upper portion of the housing 11, and a user can grasp the handle 12 when carrying the battery pack 2. The battery pack 2 is mounted in the electric vehicle 1 in an upright state in which the handle 12 faces upward, and a user can remove the battery pack 2 by holding the handle 12 and pulling it up. A battery pack 2 is accommodated in the battery exchange apparatus 3 with the handle 12 facing frontward. When loading a battery pack 2 in the battery exchange apparatus 3, a user can hold the handle 12 with one hand and support a side or bottom surface of the housing with the other hand.

The battery exchange apparatus 3 is used to accommodate and charge a battery pack 2 returned from a user, and allow a charged battery packs 2 rented out to the user in exchange for the returned battery pack 2. The battery exchange apparatus 3 is installed at a battery station located in a facility (store) such as a convenience store or a gas station.

The battery exchange apparatus 3 includes one or more battery charging units 21 and a controller 22. A battery charging unit 21 includes a plurality of battery charging modules 23, where one battery pack 2 can be mounted in each battery charging module. The battery exchange apparatus 3 may include only one battery charging unit 21 or a plurality of battery charging units 21. The controller 22 is configured to control the battery charging units 21, and communicate with the management server 4. The battery exchange apparatus 3 is connected to the management server 4 via a network such as the Internet.

The management server 4 registers a person who subscribes to a battery replacement service and uses battery packs 2, as a user (member), and manages each battery pack 2 in association with a corresponding user who rents and carries the battery pack 2. The management server 4 also manages the state of replacement of battery packs 2 in the battery exchange apparatus 3.

The management server 4 may perform user authentication to verify the identity of a user who has visited for battery replacement. In this case, the management server 4 may identify a user by face recognition performed on an image captured by a camera. The management server 4 may identify a user through communications with an RFID (radio frequency identifier) tag, a contactless IC card, or a user terminal with an NFC (Near field communication) function, carried by the user. In addition, the management server 4 may detect that a user has visited to return a battery pack 2 by reading the two-dimensional code on the battery pack 2 in an image captured by the camera.

In the present embodiment, an example of a battery pack 2 to be mounted in an electric vehicle 1 will be described, but a battery-powered device in which the battery pack 2 is to be mounted is not limited to the electric vehicle 1, and may be a portable power supply device or other suitable devices.

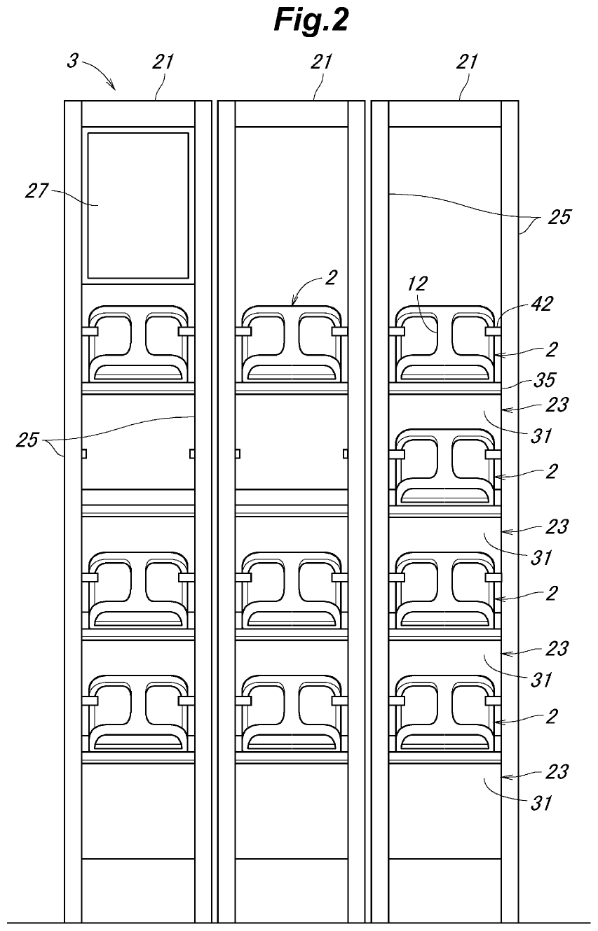

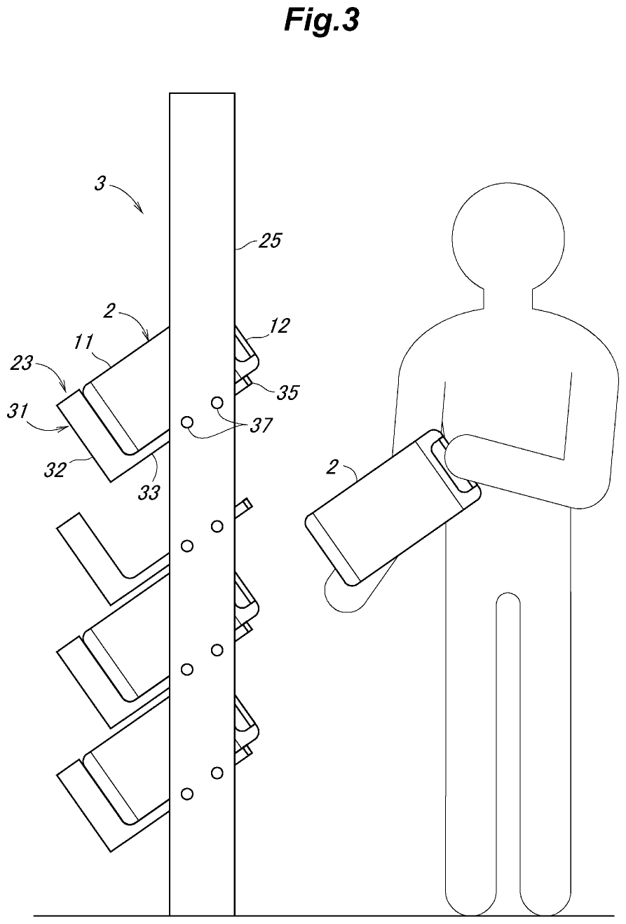

Next, a battery exchange apparatus 3 according to the first embodiment will be described. FIG. 2 is a front view of the battery exchange apparatus 3. FIG. 3 is a side view of the battery exchange apparatus 3.

As shown in FIG. 2, a plurality of battery charging modules 23 are supported by support posts 25 (supports) in the battery exchange apparatus 3. A pair of support posts 25 are provided on the left and right sides of each battery charging module 23. The battery charging modules 23 are vertically arranged to form a plurality of stages. In the example shown in FIG. 2, four battery charging modules 23 are vertically arranged to form four stages.

A battery charging unit 21 is comprised primarily of battery charging modules 23 and a pair of support posts 25. The battery exchange apparatus 3 is formed by arranging one or more battery charging units 21 side by side. In the example shown in FIG. 2, the battery exchange apparatus 3 is comprised of three battery charging units 21.

One of the battery charging units 21 of the battery exchange apparatus 3 is provided with a display module 27. The display module 27 normally operates as a digital signage for displaying contents such as advertisements, and when the battery exchange apparatus 3 detects a person who has visited for battery replacement, the display module 27 displays a guidance screen for battery replacement. The display module 27 is fixed to a pair of support posts 25; that is, left and right support posts which are located on the both sides of the display module 27 in a similar manner to a battery charging module.

As shown in FIG. 3, a battery pack 2 is mounted in a battery charging module 23 with its handle 12 facing obliquely upward. A battery charging module 23 includes trays 31 where one battery pack 2 is to be mounted on each tray. A tray 31 includes a bottom support portion 32 for supporting the bottom surface of the housing 11 of a battery pack 2, and a side support portion 33 for supporting one side surface of the battery pack 2, and has an L-shape when viewed from the side. As described above, in the present embodiment, a battery pack 2 is held in the tray 31 in an inclined state, resulting in a lower height of each stage and enabling more battery packs 2 to be accommodated in the vertical direction.

Each tray 31 of the battery charging module 23 is provided with an indicator 35 at the front end of a tray 31 for indicating a state-of-charge of the battery pack 2 on the tray. The indicator 35 indicates state-of-charges of the battery pack 2 in different colors e.g., by switching between light sources (such as LED) of different colors. For example, the indicator 35 indicates a fully-charged state (available-for-rent state) in green and an incompletely-charged state (unavailable-for-rent state) in red.

At the time of replacement of a battery pack 2, a user first searches for an empty battery charging module 23 in order to return the used battery pack 2, and mounts the used battery pack 2 in the tray 31 of the empty battery charging module 23. Next, the user searches for a fully-charged battery pack 2 available for rent, and pulls out a found fully-charged battery pack 2 from the tray 31 of the battery charging module 23.

In the present embodiment, components attached to the support posts 25 include a plurality of battery charging modules 23 for charging battery packs 2 and a plurality of display modules 27 for displaying various screens. However, such components attached to the support posts 25 may further include a module with a different function from the battery charging modules and the display modules. For example, such additional components attached to the support posts 25 may include an authentication module equipped with a camera, a card reader, or other sensors and used to perform operations for determining whether or not a user can rent a battery pack 2 through face authentication (user authentication) and operations for payment, and a communication module for communicating with the management server 4, and a solar power module for solar power generation.

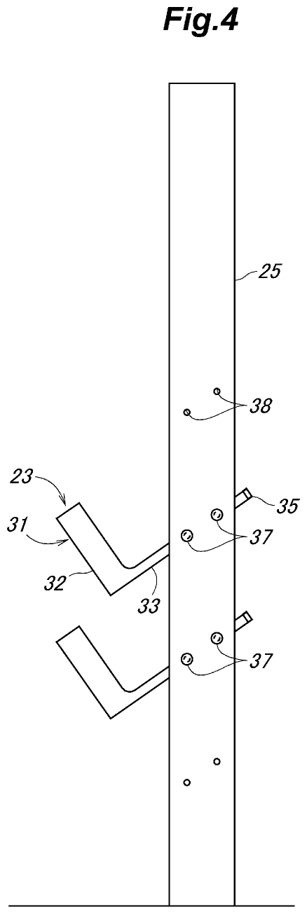

Next, an attachment structure of a battery charging module 23 according to the first embodiment will be described. FIG. 4 is an explanatory diagram showing attachment structures of battery charging modules 23.

A battery charging module 23 is detachably attached to the support posts 25 by bolts 37. A support post 25 defines attachment holes 38 which enable the maximum number of battery charging modules 23 to be attached. The battery charging module 23 is fixed to each support post 25 by fastening bolt 37 inserted through the attachment holes 38.

This attachment structure enables a battery charging module 23 to be detachably fixed to the support posts 25 with ease. Thus, after the start of operating a battery exchange apparatus 3, it is possible to increase or decrease the number of battery charging modules 23 to adjust the number attached battery charging modules 23 as necessary based on actual usage of the battery exchange apparatus 3. In the example shown in FIG. 4, only two battery charging modules 23 are attached to middle stages of the four stages.

The attachment structure of a battery charging module 23 is not limited to bolt fastening, and any other detachable attachment structure may be adopted. It is preferable that specially shaped bolts are used so that only the builder of a battery station can easily remove bolts, or a concealing member is attached to a support post 25 to obscure the bolts.

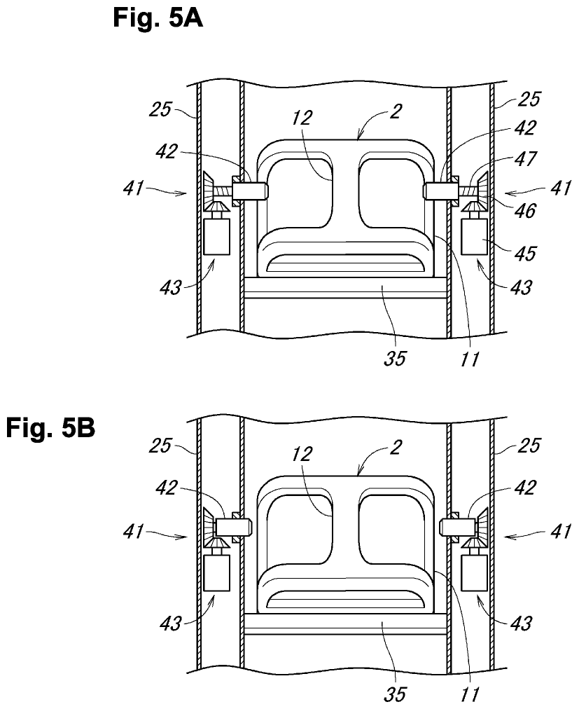

Next, a locking mechanism 41 of a battery exchange apparatus 3 according to the first embodiment will be described. FIG. 5 is an explanatory diagram showing a locking mechanism 41 of a battery exchange apparatus 3.

The battery exchange apparatus 3 includes a locking mechanism 41 for preventing a battery pack 2 from removed from the tray 31 of a battery charging module 23. The locking mechanism 41, which prevents the battery pack 2 from being pulled out, can prevent an incompletely-charged battery pack 2 from accidentally being rent out. When user authentication is performed to verify the identity of a user who has visited, the locking mechanism 41 can prevent a battery pack 2 from accidentally being rent out to an unauthenticated user.

The locking mechanism 41 is provided on a support post 25, and includes a locking pin 42 (locking member) for restricting the movement of a battery pack 2, and a driver 43 for moving the locking pin 42 in an axial direction between a locked position and an unlocked position. In the example shown in FIG. 5, a bevel gear 46 and a feed screw 47 are used to advance and retreat the locking pin 42 in the axial direction according to the rotation of an electric motor 45. However, a configuration of the driver 43 is not limited to that shown in the figure. For example, an actuator other than an electric motor (e.g., a solenoid) may be used to move the locking pin 42.

In the locked position as shown in FIG. 5A, the locking pin 42 projects toward the handle 12 of the housing 11 of a battery pack 2 to prevent the battery pack 2 from being removed from the tray 31. When being retracted, the locking pin 42 transitions to the unlocked position as shown in FIG. 5B. In this unlocked state, the locking pin 42 is not located at the handle 12 of the housing 11 of a battery pack 2, allowing the battery pack 2 to be removed from the tray 31.

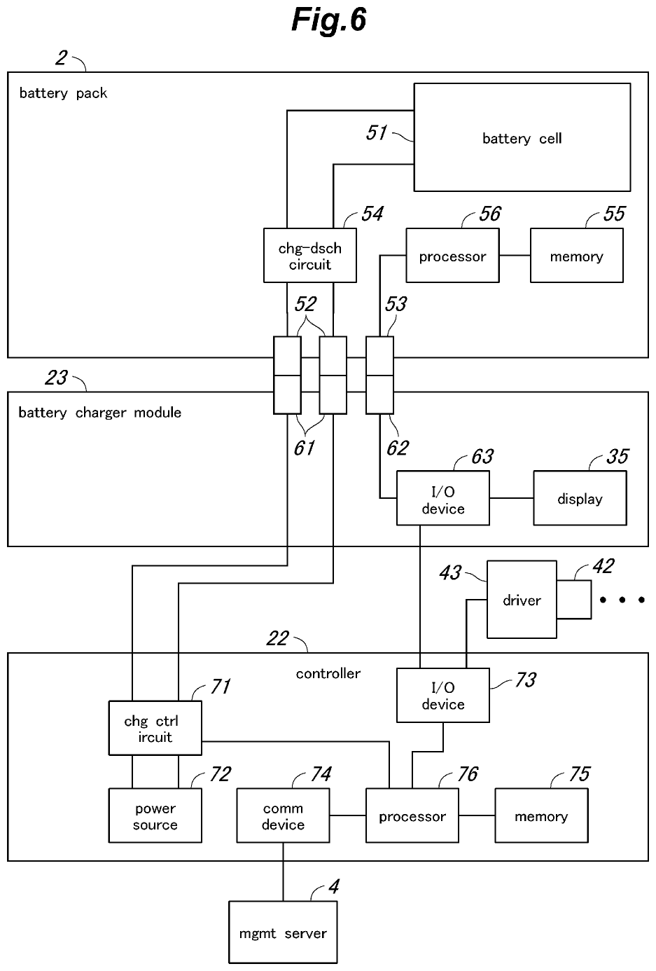

Next, schematic configurations of a battery pack 2 and a battery charging module 23 according to the first embodiment will be described. FIG. 6 is a block diagram showing schematic configurations of a battery pack 2 and a battery charging module 23.

A battery pack 2 includes a battery cell 51, a power transmitter terminal 52, a communication terminal 53, a charge/discharge circuit 54, a memory 55, and a processor 56.

The power transmitter terminal 52 is used to transmit charging power supplied from the battery charging module 23 at the time of charging. When the battery pack is mounted on an electric vehicle 1, the power transmitter terminal 52 is used to transmit electric power from the battery cell 51 to the electric vehicle 1.

The communication terminal 53 transmits/receives information between the battery charging module 23 and the battery pack 2. The power transmitter terminal 52 may also be used as a communication terminal.

The charge/discharge circuit 54 performs an operation of charging the battery cell 51 with charging power supplied from the battery charging module 23 and an operation of having the battery cell 51 discharged to deliver electric power to the electric vehicle 1 for driving.

The memory 55 stores programs executable by the processor 56. The memory 55 stores battery management information required for managing a battery replacement service. Examples of types of battery management information include a battery pack ID (individual ID information such as a serial number) of a battery pack 2, a user ID of a user using the battery pack 2, an alert indicating an abnormal condition of the battery pack 2, history information such as the number of past charges, degradation information on battery degradation of the battery cell 51, and other information.

The processor 56 controls each part of the battery pack 2. For example, when various environmental sensors (such as temperature, humidity, voltage, and current sensors) are provided, the processor 56, based on signals from the sensors, detects an abnormality or degradation state of the battery cell 51, and stores an alert or degradation information in the memory 55.

A battery charging module 23 includes, in addition to the indicator 35, a power transmitter terminal 61, a communication terminal 62, and an input/output device 63.

The power transmitter terminal 61 is used to transmit charging power supplied from the controller 22 at the time of charging the battery pack 2.

The communication terminal 62 transmits/receives information between the battery charging module 23 and the battery pack 2. The power transmitter terminal 61 may also be used as a communication terminal.

The input/output device 63 relays the transmission of information between the controller and the battery pack 2.

The controller 22 includes a charge control circuit 71, a power supply 72, an input/output device 73, a communication device 74, a memory 75, and a processor 76.

The charge control circuit 71 controls charging power supplied from the power supply 72 to the battery charging module 23.

The communication device 74 communicates with the management server 4. Specifically, the communication device 74 transmits battery management information (such as the battery pack ID of a battery pack 2) acquired from the battery pack 2 to the management server 4. Furthermore, the communication device 74 receives control information related to the possibility of charging and a target charge amount for each battery pack 2 from the management server 4. Based on the control information, the controller can control the timing of charging and the charging amount for each battery pack 2. The communication device 74 may receive information on the availability of a battery pack for rent from the management server 4 so that the processor 76 can perform a rental operation for selecting the battery pack 2 to be rented out. The communication device 74 may transmit authentication information (such as face image, RFID user ID) acquired for user authentication, to the management server 4 or an authentication server (not shown), and then receives an authentication result from the management server 4 or the authentication server, so that the processor 76 can determine whether or not a user is allowed to rent the battery pack 2.

The memory 75 stores programs executable by the processor 76.

The processor 76 controls the charging of a battery pack 2 in the battery charging module 23. Specifically, the processor 76 controls the charge control circuit 71 based on information acquired from the battery pack 2 via the input/output device 73. Furthermore, the processor 76 controls the indicator 35 based on charging information acquired from the battery pack 2, so that the indicator 35 can indicate a state-of-charge of the battery pack 2 in a corresponding color. Moreover, the processor 76 controls the driver 43 used to advance and retreat the locking pin 42 for preventing the battery pack 2 from being removed from the tray 31 of the battery charging module 23.

Movement path records of the electric vehicle 1 (for example, position data of the electric vehicle 1 at times acquired by using a positioning system such as GPS) may be stored in the memory 55 in the battery pack 2. In this case, the processor 76 may transmit the movement path records from the battery pack 2 to the management server 4 via the battery exchange apparatus 3. When the electric vehicle 1 is equipped with a camera as a vehicle traveling data recorder (VTDR), video data may be stored in the memory 55 in the battery pack 2 within the memory capacity for the VTDR and the processor 76 may transmit the video data from the battery pack 2 to the management server 4 via the battery exchange apparatus 3.

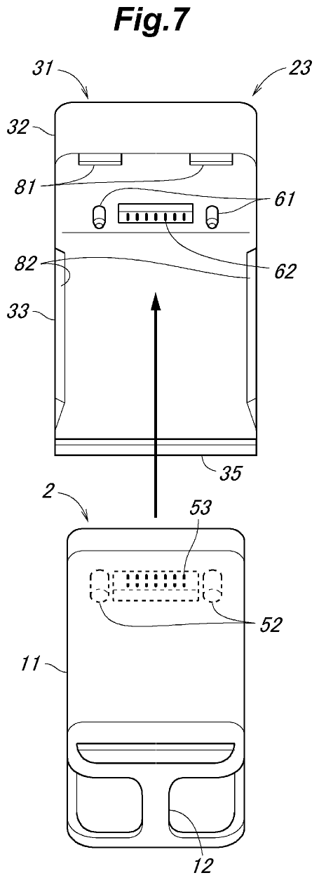

Next, a guide structure for the battery pack 2 in a battery charging module 23 according to the first embodiment will be described. FIG. 7 is an explanatory diagram showing a guide structure for the battery pack 2 in a battery charging module 23.

The tray 31 of the battery charging module 23 is provided with a power transmitter terminal 61 and a communication terminal 62 at the bottom support portion 32. The battery pack 2 is provided with a power transmitter terminal 52 and a communication terminal 53 at the bottom surface thereof. When the battery pack 2 is mounted on the tray 31, the power transmitter terminal 61 and the communication terminal 62 of the tray 31 are joined to the power transmitter terminal 52 and the communication terminal 53 of the battery pack 2, respectively.

A guide portion 81 is provided on the bottom support portion 32 of the tray 31 and guide portions 82 are provided on the side support portions 33 of the tray 31. The guide portions 81 and 82 guide the battery pack 2 to a regular mounting position in which the power transmitter terminal 61 and the communication terminal 62 of the tray 31 are aligned with the power transmitter terminal 52 and communication terminal 53 of the battery pack 2, respectively.

### First Variant of First Embodiment

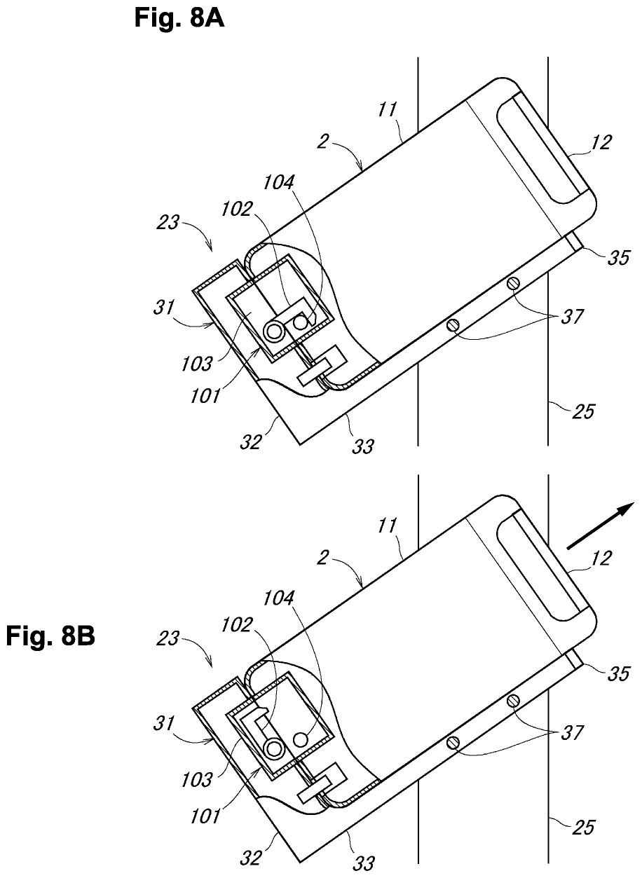

Next, a first variant of the first embodiment will be described. Except for what will be discussed here, the first variant is the same as the above-described first embodiment. FIG. 8 is an explanatory diagram showing a locking mechanism 101 of the battery exchange apparatus 3 according to the first variant of the first embodiment.

In the first embodiment (see FIG. 5), a support post 25 is provided with the locking pin 42 (locking member) and its driver 43, which form the locking mechanism 41 for preventing a battery pack 2 from being removed from the battery charging module 23. In the first variant of the first embodiment, a battery charging module 23 is provided with a hook 102 (locking member) and its driver 103, which form a locking mechanism 101.

In a locked state as shown in FIG. 8A, the hook 102 of the tray 31 is engaged with a stopper 104 provided on a battery pack 2 to prevent the battery pack 2 from being removed from the tray 31. In an unlocked state as shown in FIG. 8B, the hook 102 is not engaged with the stopper 104, allowing the battery pack 2 to be removed from the tray 31.

Although, in the example shown in FIG. 8, the hook 102 (locking member) is engaged with the stopper 104 to prevent the battery pack 2 from being removed, the locking mechanism is not limited to such a configuration.

In this first variant of the first embodiment, a configuration of the first embodiment is generally adopted and modified such that the locking member and its driver which form the locking mechanism are provided in the battery charging module. However, a general configuration of any of other embodiments described later may be adopted and modified such that a locking member and its driver which form a locking mechanism are provided in the battery charging module.

### Second Variant of First Embodiment

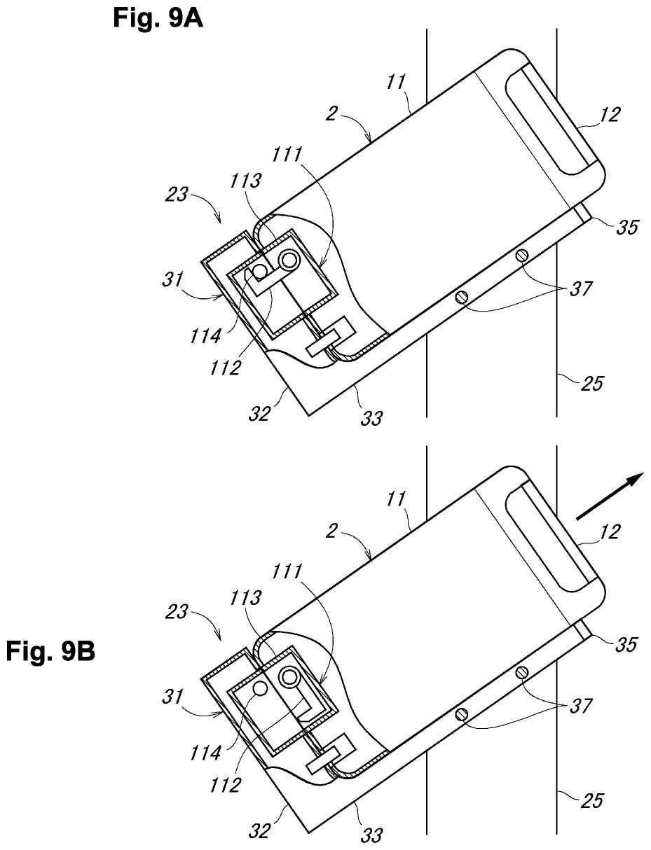

Next, a second variant of the first embodiment will be described. Except for what will be discussed here, the second variant is the same as the above-described embodiments. FIG. 9 is an explanatory diagram showing a locking mechanism 111 of the battery exchange apparatus 3 according to the second variant of the first embodiment.

In the first variant of the first embodiment (see FIG. 8), a battery charging module 23 is provided with the hook 102 (locking member) and its driver 103, which form a locking mechanism 101 for preventing the battery pack 2 from being removed from the battery charging module 23. In the second variant of the first embodiment, a battery pack 2 is provided with a hook 112 (locking member) and its driver 113, which form a locking mechanism 111.

In a locked state as shown in FIG. 9A, the hook 112 of a battery pack 2 is engaged with a stopper 114 provided on a tray 31 to prevent the battery pack 2 from being removed from the tray 31. In an unlocked state as shown in FIG. 9B, the hook 112 is not engaged with the stopper 114, allowing the battery pack 2 to be removed from the tray 31.

Although, in the example shown in FIG. 9, the hook 112 (locking member) is engaged with the stopper 114 to prevent the battery pack 2 from being removed, the locking mechanism is not limited to such a configuration.

In this second variant of the first embodiment, the locking member (hook 112) of a battery pack 2 is engaged with a tray 31 of a battery charging module 23 to prevent the battery pack 2 from being removed from the tray 31. In other cases, the locking member (hook 112) of a battery pack 2 is engaged with a support post 25 (support) to prevent the battery pack 2 from being removed. For example, a locking pin (locking member) may be retractably provided at a side of a battery pack 2 such that the locking pin can fit into a hole defined in the support post 25 to thereby prevent the battery pack 2 from being removed.

In this second variant of the first embodiment, a general configuration of the first embodiment is adopted and modified such that the locking member and its driver which form the locking mechanism are provided in a battery pack. However, a general configuration of any of other embodiments described later may be adopted and modified such that a locking member and its driver which form a locking mechanism are provided in a battery pack.

### Second Embodiment

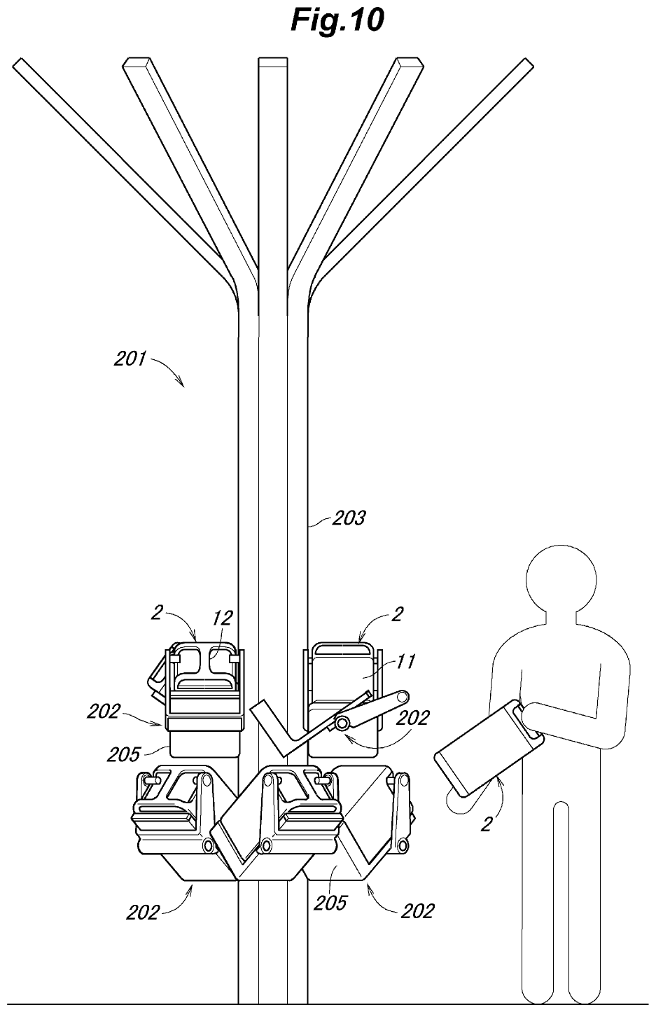

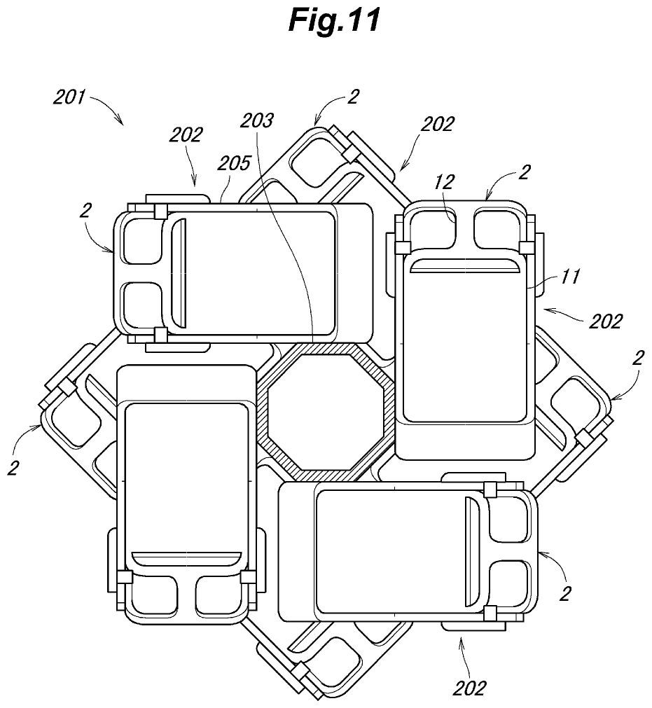

Next, a second embodiment of the present disclosure will be described. Except for what will be discussed here, the second embodiment is the same as the above-described embodiments. FIG. 10 is a front view of a battery exchange apparatus 201 according to the second embodiment. FIG. 11 is a plan view of the battery exchange apparatus 201 according to the second embodiment.

As shown in FIG. 10, a plurality of battery charging modules 202 are supported by a support post 203 (support) of the battery exchange apparatus 201. The plurality of battery charging modules 202 are provided circumferentially around the support post 203 at predetermined intervals. In the example shown in FIG. 10, the four battery charging modules 202 are provided around the support post at intervals of 90 degrees.

Each battery pack 2 is mounted in a tray 205 of a battery charging module 202 with its handle 12 facing obliquely upward.

The battery charging modules 202 are vertically arranged to form a plurality of stages. In the example shown in FIG. 10, two battery charging modules 202 are vertically arranged to form two stages.

In this configuration of the battery exchange apparatus 201, a user walks around the battery exchange apparatus 201 to search for an empty tray 205 or a fully charged battery.

As shown in FIG. 11, the upper battery charging modules 202 and the lower battery charging modules 202 are circumferentially arranged and angularly displaced with respect to each other. In the example shown in FIG. 11, the upper battery charging modules 202 and the lower battery charging modules 202 are angularly displaced 45 degrees with respect to each other.

A battery charging modules 202 is attached to a support post 203 such that a side of the tray 205 is fixed to the support post 203. This attachment structure can reduce the dimension of a radially protruding part of a module, thereby minimizing the space the battery exchange device occupies.

The battery charging module 202 is detachably fixed to the support post 203 with bolts (not shown). This attachment structure enables the number of the battery charging modules 202 attached to the support post 203 to be adjusted depending on the actual usage of the battery exchange apparatus 201.

As shown in FIG. 10, the battery exchange apparatus 201 is formed to have a tree-like shape as a whole. Specifically, radially extending portions of the upper end of the support post 203 create figures of tree branches and a plurality of battery modules create shapes of fruits of a tree. In some cases, lamps may be provided at the radially extending portions of the upper end of the support post 203 so that the support post can also be used as a street lamp. In other cases, a cover may be provided at the radially extending portions of the upper end of the support post 203 so that the cover can be used as a rain hood or a shading cover.

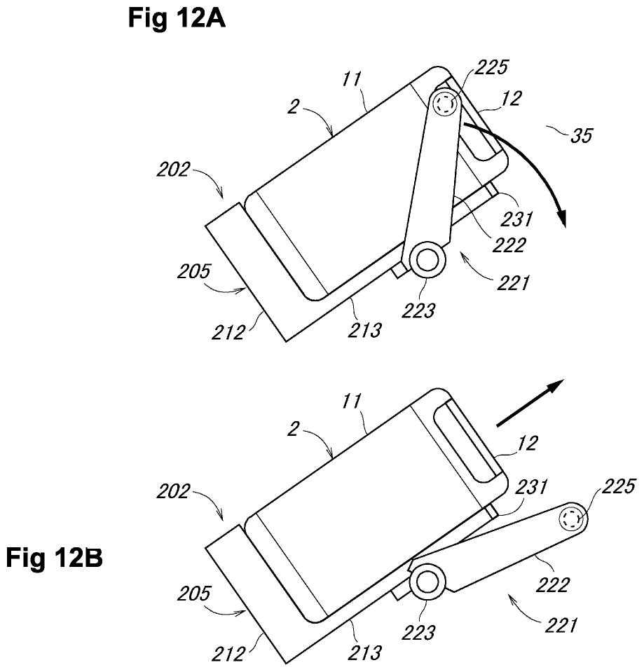

Next, a locking mechanism 221 of the battery exchange apparatus 201 according to the second embodiment will be described. FIG. 12 is an explanatory diagram showing a locking mechanism 221 of the battery exchange apparatus 201.

In the present embodiment, the battery charging module 202 is provided with an arm 222 and its driver 223 which form a locking mechanism 221 for preventing a battery pack 2 from being removed the tray 205. The base end of the arm 222 is rotatably attached to the tray 205. A locking pin 225 (locking member) is provided at the tip end of the arm 222. The driver 223 includes an actuator such as an electric motor.

In a locked state as shown in FIG. 12A, the locking pin 225 is projects to the handle 12 of a housing 11 of a battery pack 2 to prevent the battery pack 2 from being removed from the tray 205. When the arm 222 is rotated, the locking pin 42 transitions to an unlocked state as shown in FIG. 12B. In this unlocked state, the locking pin 225 is not located at the handle 12 of the housing 11 of a battery pack 2, allowing the battery pack 2 to be removed from the tray 31.

The tray 505 of a battery charging module 202 includes a bottom support portion 212 for supporting the bottom surface of the housing 11 of a battery pack 2, and a side support portion 213 for supporting one side surface of the battery pack 2, and has an L-shape when viewed from the side, in the same manner as the first embodiment. The tray 505 of the battery charging module 23 is provided with an indicator 231 at the front end of the tray 505 for indicating a state-of-charge of a battery pack 2 on the tray.

### Third Embodiment

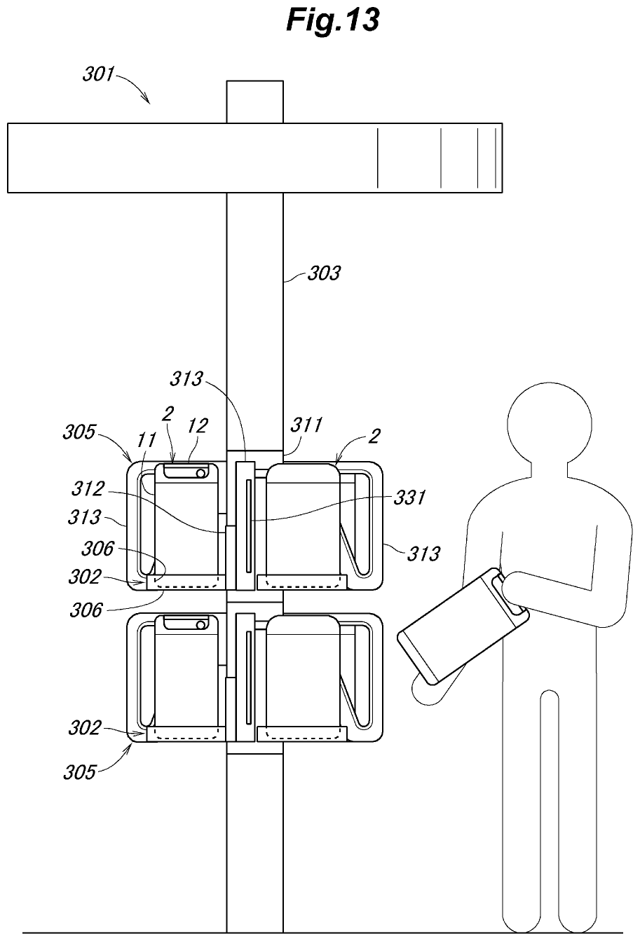

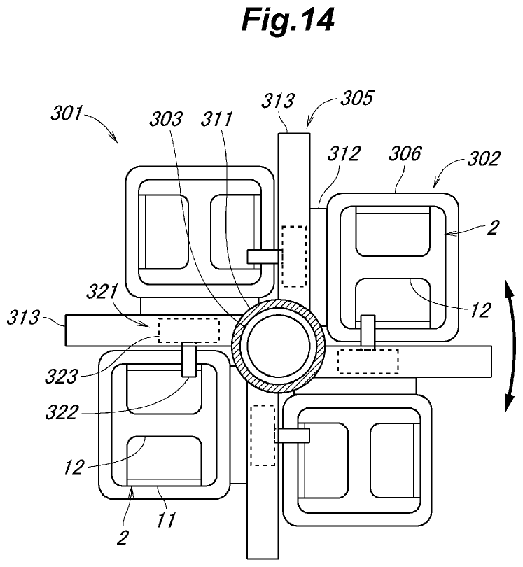

Next, a third embodiment of the present disclosure will be described. Except for what will be discussed here, the third embodiment is the same as the above-described embodiments. FIG. 13 is a front view of a battery exchange apparatus 301 according to the third embodiment. FIG. 14 is a side view of the battery exchange apparatus 301.

As shown in FIG. 13, in the present embodiment, a plurality of battery charging modules 302 are supported by a support post 303 (support) of the battery exchange apparatus 301 in a similar manner to the second embodiment. The third embodiment is different from the second embodiment in that the plurality of battery charging modules 302 are supported by the support post 303 via a support frame 305 that is rotatable around a central axis (vertical axis) of the support post 303.

A battery charging module 302 includes a tray 306 for holding a battery pack 2. The battery pack 2 is held in the tray 306 in an upright state. Specifically, the tray 306 is provided with a recess 307, and the bottom portion of the battery pack 2 is fitted into the recess 307. A user can fit the battery pack 2 into the recess 307 of the tray 306 from above the tray 306, so that the battery pack 2 is mounted on the tray 306.

As shown in FIG. 14, the support frame 305 includes a central cylindrical portion 311, a tray support portion 312, and a handle portion 313. The tray support portion 312 and the handle portion 313 project radially from the outer circumferential surface of the central cylindrical portion 311. The central cylindrical portion 311 is rotatably attached to the support post 303 so as to be rotatable around the central axis (vertical axis) of the support post 303. The tray 306 is fixed to the tray support portion 312 and the handle portion 313. A user can easily rotate the support frame 305 and battery charging modules 302 supported by the support frame 305 by pushing the handle portion 313.

As described above, in the present embodiment, the battery charging modules 302 rotate around the support post 303. Thus, a user does not need to walk around the battery exchange apparatus 301 when searching for an empty battery charging module 302 or a fully charged battery pack 2.

The handle portion 313 is provided with a locking pin 322 (locking member) and its driver 323 for moving the locking pin 322 forward and backward, which form a locking mechanism 321. The locking pin 322 projects to the handle 12 of the housing 11 of the battery pack 2 to prevent the battery pack 2 from being removed from the tray.

As shown in FIG. 13, the handle portion 313 is provided with an indicator 331 at the front end of the handle portion 313 for indicating a state-of-charge of a battery pack 2 on the tray.

Furthermore, the tray 306 of a battery charging module 302 is detachably fixed to the support frame 305 with bolts (not shown). This attachment structure enables the number of the battery charging modules 302 attached to the support frame 305 to be adjusted depending on the actual usage of the battery exchange apparatus 301.

### Fourth Embodiment

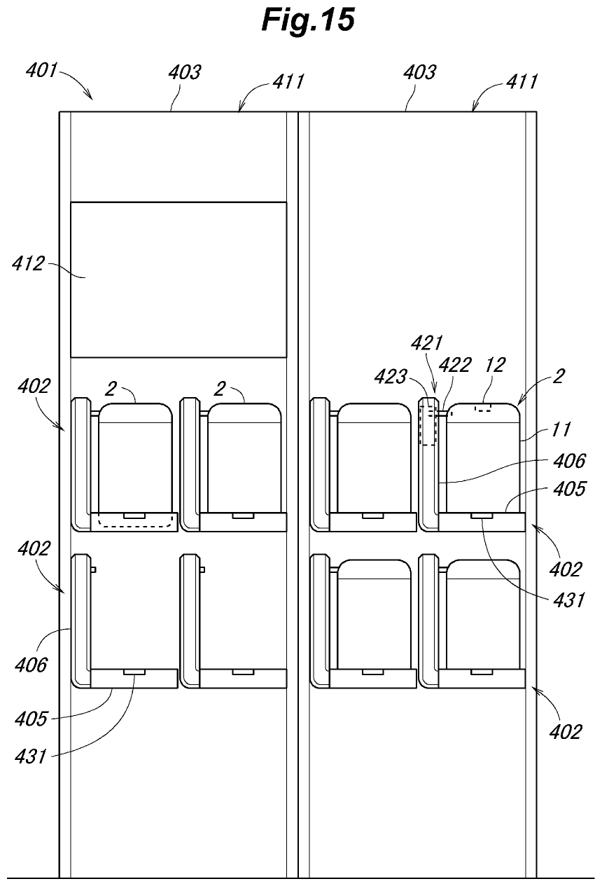

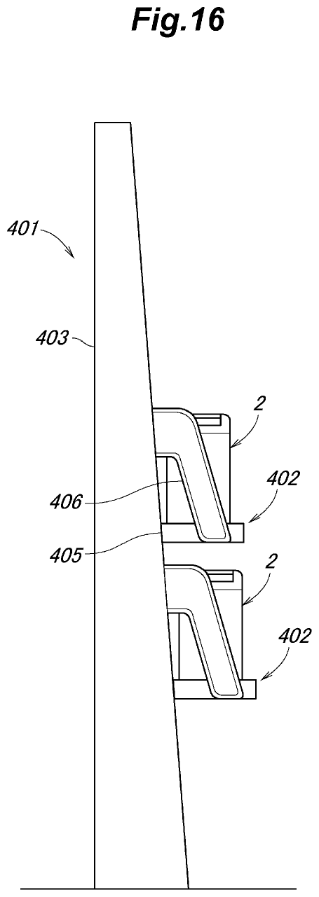

Next, a fourth embodiment of the present disclosure will be described. Except for what will be discussed here, the fourth embodiment is the same as the above-described embodiments. FIG. 15 is a front view of a battery exchange apparatus 401 according to the fourth embodiment. FIG. 16 is a side view of the battery exchange apparatus 401.

As shown in FIG. 15, in the present embodiment, battery charging modules 402 are supported by a support panel 403 (support) of the battery exchange apparatus 401. A plurality of battery charging modules 402 are arranged side by side in the left-right direction (horizontal direction) and the up-down direction (vertical direction) on the front surface of the support panel 403.

The support panel 403 and a plurality of battery charging modules 402 supported by the support panel 403 form a battery charging unit 411. One or more battery charging units 411 are arranged side by side to form the battery exchange apparatus 401. In the case of a single battery charging unit 411, a display 412 is provided on the support panel 403.

As shown in FIG. 16, a battery charging module 402 includes a tray 405 on which a battery pack 2 is to be mounted, and a bracket 406 for supporting the tray 405. A battery pack 2 is mounted on the tray 405 in an upright state in a similar to the third embodiment (see FIG. 13). This configuration can reduce the depth size of the battery exchange apparatus 401.

A battery charging module 402 is fixed to the front side of the support panel 403. Both the tray 405 and the bracket 406 may be fixed to the support panel 403. In some cases, only the bracket 406 may be fixed to the support panel 403.

The tray 405 and the bracket 406 of the battery charging module 402 are detachably fixed to the support panel 403 with bolts (not shown). This attachment structure enables the number of the battery charging modules 402 attached to the support panel 403 to be adjusted depending on the actual usage of the battery exchange apparatus 401. The bracket 406 may be fixed to the support panel 403 such that only the tray 405 can be detachably attached.

As shown in FIG. 15, the bracket 406 is provided with a locking pin 422 (locking member) and its driver 423 for moving the locking pin 422 forward and backward, which form a locking mechanism 421. The locking pin 422 projects to the handle 12 of the housing 11 of the battery pack 2 to prevent the battery pack 2 from being removed from the tray.

The tray 405 is provided with an indicator 431 at the front end of the tray 405 for indicating a state-of-charge of a battery pack 2 on the tray.

### Fifth Embodiment

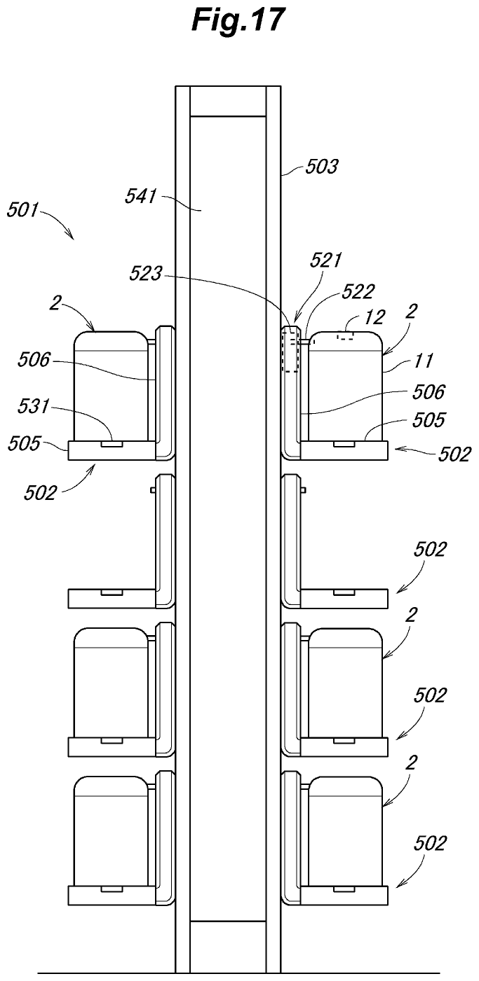

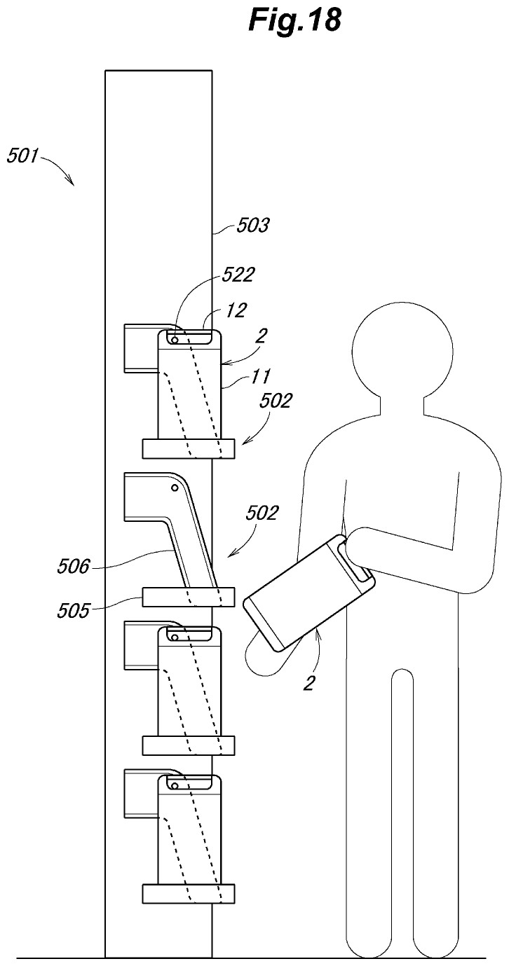

Next, a fifth embodiment of the present disclosure will be described. Except for what will be discussed here, the fifth embodiment is the same as the above-described embodiments. FIG. 17 is a front view of a battery exchange apparatus 501 according to the fifth embodiment. FIG. 18 is a side view of the battery exchange apparatus 501.

As shown in FIGS. 17 and 18, in the present embodiment, battery charging modules 502 are supported by a support post 503 (support) of the battery exchange apparatus 501. A plurality of battery charging modules 502 are arranged on the both sides of the support post 503. The battery charging modules 502 are vertically arranged to form a plurality of stages.

A battery charging module 502 includes a tray 505 on which a battery pack 2 is to be mounted, and a bracket 506 for supporting the tray 405 in a similar manner to the fourth embodiment. A battery pack 2 is mounted on the tray 505 in an upright state. The bracket 506 is fixed to the support post 503.

The battery charging module 502 is detachably fixed to the support post 503 with bolts (not shown). This attachment structure enables the number of the battery charging modules 502 attached to the support post 503 to be adjusted depending on the actual usage of the battery exchange apparatus 501. The bracket 406 may be fixed to the support post 503 such that only the tray 405 can be detachably attached.

As shown in FIG. 17, the bracket 506 is provided with a locking pin 522 (locking member) and its driver 523 for moving the locking pin 522 forward and backward, which form a locking mechanism 521 for preventing a battery pack 2 from being removed. The locking pin 522 projects to the handle 12 of the housing 11 of the battery pack 2 to prevent the battery pack 2 from being removed from the tray.

The tray 505 is provided with an indicator 531 at the front end of the tray 505 for indicating a state-of-charge of a battery pack 2 on the tray.

The support post 503 is provided with a vertically long display 541 at the front side of the support post. The display 541 normally operates as a digital signage for displaying contents such as advertisements.

### Sixth Embodiment

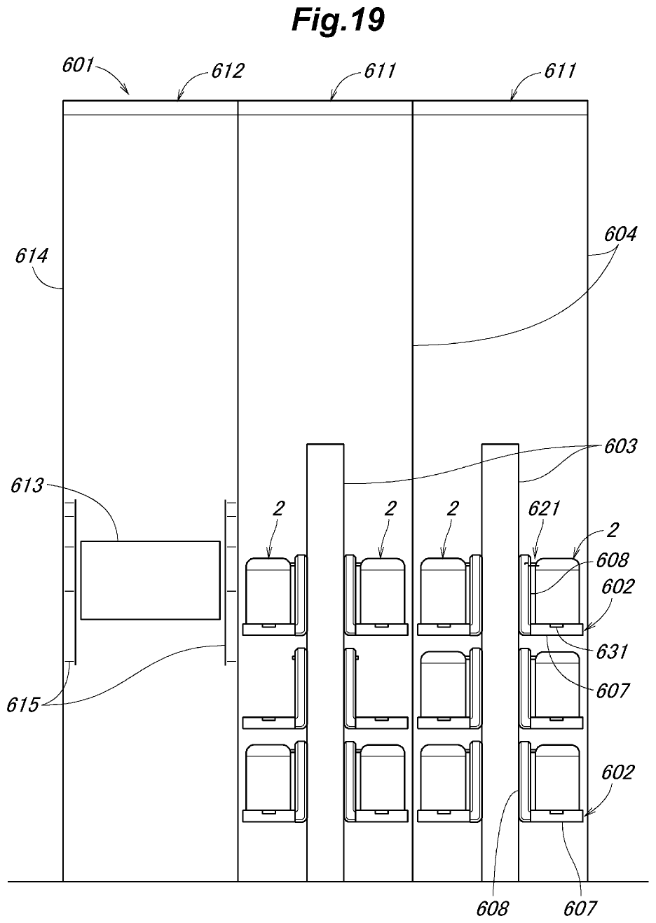

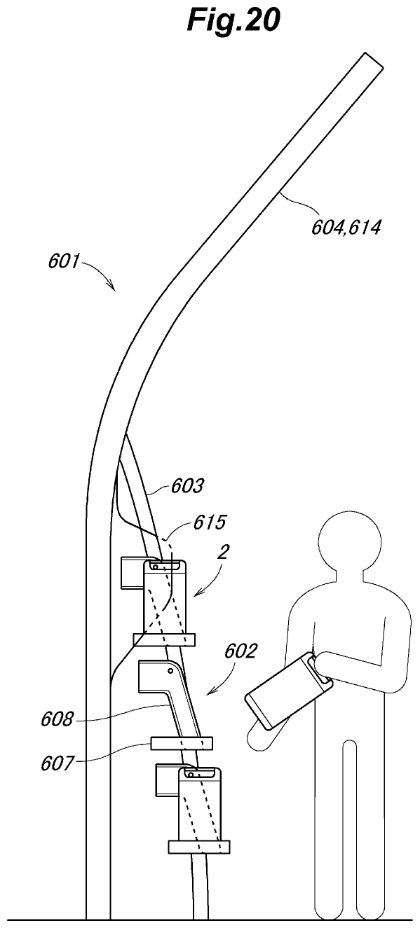

Next, sixth embodiment of the present disclosure will be described. Except for what will be discussed here, the sixth embodiment is the same as the above-described embodiments. FIG. 19 is a front view of a battery exchange apparatus 601 according to the sixth embodiment. FIG. 20 is a side view of the battery exchange apparatus 601.

As shown in FIG. 19, in the present embodiment, a plurality of battery charging modules 602 are supported by both sides of each of the support posts 603 (supports) of the battery exchange apparatus 601 in a similar manner to the fifth embodiment. The upper end of each support post 603 is connected to a corresponding support panel 604 provided on the back side of the support post 603 such that the support post 603 is supported by the support panel 604. A battery charging module 602 includes a tray 607 and a bracket 608, as in the fourth embodiment.

A display unit 612 is provided adjacent to a battery charging unit 611, which is comprised primarily of battery charging modules 602, a support post 603, and a support panel 604. The display unit 612 includes a display 613 provided on the support panel 614. The display 613 displays a screen related to face recognition or other information, and a user can operate the screen. Privacy panels 615 are provided on both sides of the display 613.

The bracket 608 is provided with a locking mechanism 621 for preventing the battery pack 2 from being removed from the tray 607 in a similar manner to the fifth embodiment (see FIG. 17). An indicator 631 for displaying a state-of-charge of a battery pack 2 is provided on the front surface of the tray 505.

The battery charging module 602 is detachably fixed to the support post 603 with bolts (not shown). This attachment structure enables the number of the battery charging modules 602 attached to the support post 503 to be adjusted depending on the actual usage of the battery exchange apparatus 601. The bracket 608 may be fixed to the support post 603 such that only the tray 607 can be detachably attached.

As shown in FIG. 20, the support panels 604 and 614 have a curved shape with their upper ends that are inclined frontward. The upper end portion of each of the support panels 604 and 614 serves as a rain hood or a shading cover.

### Seventh Embodiment

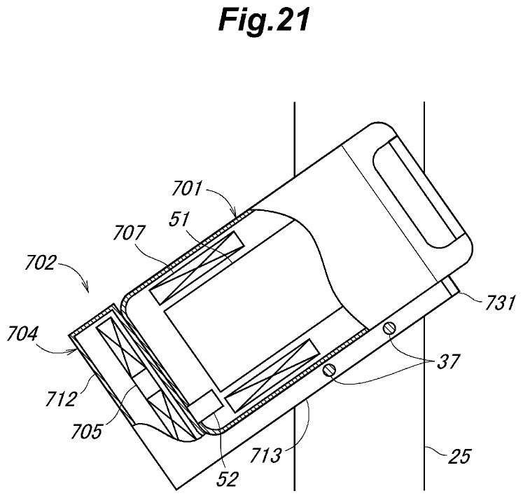

Next, a seventh embodiment of the present disclosure will be described. Except for what will be discussed here, the seventh embodiment is the same as the above-described embodiments. FIG. 21 is an explanatory diagram showing a battery pack 701 and a battery charging module 702 according to the seventh embodiment.

In the first embodiment (see FIG. 7), the power transmitter terminal 52 provided in the battery charging module 23 and the power transmitter terminal 61 provided in the battery pack 2 are joined to each other so that the battery charging module 23 can supply charging power to the battery pack 2. In the present embodiment, the battery charging module 702 transmits charging power to the battery pack 701 through wireless power supply (contactless power supply); that is, by electromagnetic induction.

The tray 704 of the battery charging module 702 is provided with a power transmitter coil 705. The battery pack 701 includes a power receiver coil 707, as well as the battery cell 51 and the power transmitter terminal 52.

The tray 704 of the battery charging module 702 includes a bottom support portion 712 for supporting the bottom surface of the housing of the battery pack 701 and a side support portion 713 for supporting one side surface of the battery pack 2, and has an L-shape when viewed from the side, in a similar manner to the first embodiment. The tray 704 is provided with an indicator 731 at the front end of the tray 704 for indicating a state-of-charge of a battery pack 2 on the tray.

In the example shown in FIG. 21, a configuration of the first embodiment is generally adopted and modified such that wireless power supply is used between the battery pack 2 and the battery charging module 23. However, a general configuration of any of other embodiments may be adopted and modified such that wireless power supply is used between a battery pack 2 and a battery charging module.

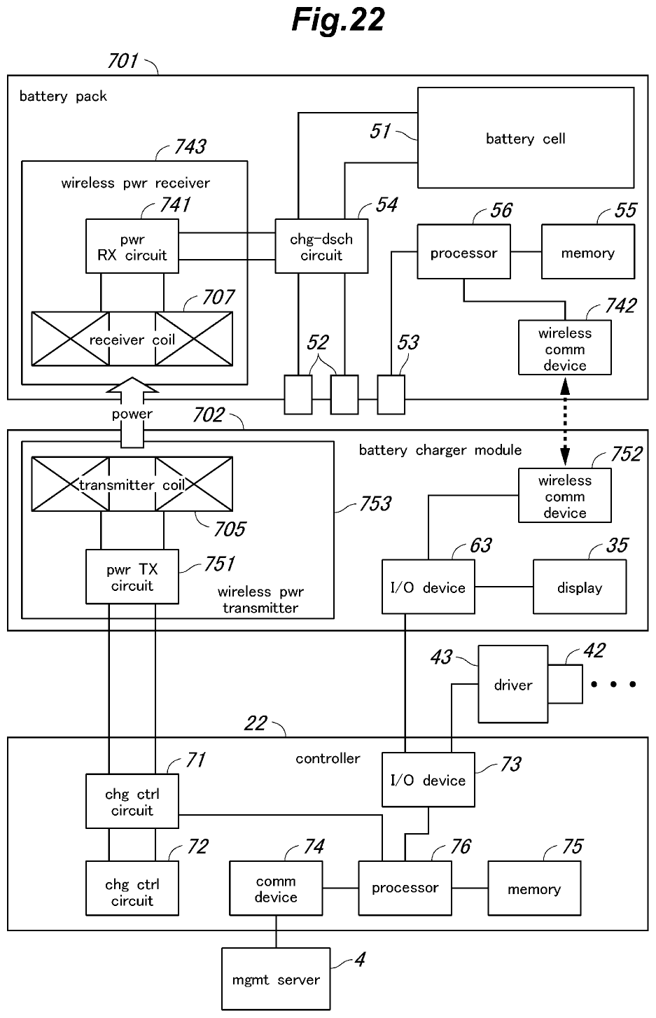

Next, a battery pack 701 and a battery charging module 702 according to the seventh embodiment will be described. FIG. 22 is a block diagram showing schematic configurations of a battery pack 701 and a battery charging module 702. The configuration of the controller 22 is the same as that of the first embodiment (see FIG. 6).

The battery pack 701 includes a power receiver circuit 741 and a wireless communication device 742, in addition to the power receiver coil 707. The power receiver coil 707 and the power receiver circuit 741 form a wireless power receiver 743.

The power receiver circuit 741 converts an alternating current induced in the power receiver coil by electromagnetic induction between the power receiver coil and the power transmitter coil 705, into electric power (DC power) at a predetermined voltage, and provides the electric power to the charge/discharge circuit 54. The other parts of the battery pack and the battery charging module are the same as those of the first embodiment (FIG. 6).

The wireless communication device 742 performs wireless communications (short-range communications) with the battery charging module 702. Specifically, the wireless communication device 742 transmits battery management information (such as the battery pack ID of a battery pack 2) stored in the memory 55 to the battery charging module 702. The wireless communications (short-range communications) utilize, for example, Wi-Fi (registered trademark) communications, Bluetooth (registered trademark) communications, infrared communications, or RFID (Radio Frequency Identifier).

Since the battery charging module 23 wirelessly transmits power to and performs communications with a battery pack, the power transmitter terminal 52 and the communication terminal 53 of the battery pack are not used therebetween. However, since a battery pack supplies power to and communicates with an electric vehicle 1 by wire through a power transmitter terminal 52 and a communication terminal 53, the battery pack needs to include the power transmitter terminal 52 and the communication terminal 53.

The battery charging module 702 includes a power transmitter circuit 751 and a wireless communication device 752 in addition to the power transmitter coil 705. The power transmitter coil 705 and the power transmitter circuit 751 form a wireless power transmitter 753.

The power transmitter circuit 751 converts power (DC power) supplied from the controller 22 into an AC voltage with a predetermined frequency, and supplies the power to the power transmitter coil 705.

The wireless communication device 752 performs wireless communications (short-range communications) with the battery pack 701. Specifically, the wireless communication device 752 receives battery management information (such as the battery pack ID of the battery pack) transmitted from the battery pack 701. The wireless communications (short-range communications) utilize, for example, Wi-Fi (registered trademark) communications, Bluetooth (registered trademark) communications, infrared communications, or RFID (Radio Frequency Identifier).

Specific embodiments of the present disclosure are described herein for illustrative purposes. However, the present disclosure is not limited to those specific embodiments, and various changes, substitutions, additions, and omissions may be made for features of the embodiments without departing from the scope of the invention. In addition, elements and features of the different embodiments may be combined with each other to yield an embodiment which is within the scope of the present disclosure.

### INDUSTRIAL APPLICABILITY

A battery charging module, a battery exchange device, and a battery device according to the present disclosure, ensure that a necessary change in the scale of a battery exchange device can be made with ease and at low cost even after the start of operating a service, and eliminate the need for any feature for rainwater resistance to thereby enable the battery exchange device to be made simple, and are useful as a battery charging module, a battery exchange device, and a battery device, where the battery charging module is configured to hold the battery device, and where a plurality of the battery charging module are attached to a support to form a battery exchange device.

### Glossary

1 electric vehicle
2 battery pack (battery device)
3 battery exchange apparatus (battery exchange device)
11 housing
12 handle
23, 702 battery charging module
25 support post (support)
31, 703 tray
35 display
37 bolt
38 attachment hole
705 power transmitter coil
707 power receiver coil
741 power receiver circuit
742 wireless communication device
743 wireless power receiver
751 power transmitter circuit
752 wireless communication device
753 wireless power transmitter

1. A battery charging module for holding a battery device, wherein the battery charging module is detachably attached to a support, and wherein a plurality of the battery charging module are attached to the support to form a battery exchange device,
wherein the battery charging module comprises a tray for guiding a battery device to a predetermined mounting position and holding the battery device at the mounting position,
wherein the tray comprises:
a wireless power transmitter for transmitting charging power to the battery device in a non-contact manner; and
a wireless communication device for transmitting and receiving battery management information to and from the battery device in a non-contact manner.

2. The battery charging module according to claim 1, wherein the wireless communication device performs wireless communications with the battery device utilizing wireless LAN communications, short-range wireless communications, or infrared communications.

3. The battery charging module according to claim 1, wherein the tray comprises an indicator for indicating a state-of-charge of the battery device.

4. The battery charging module according to claim 1, wherein the tray comprises a locking member for preventing the battery device from being removed from the mounting position, and a driver for driving the locking member.

5. The battery charging module according to claim 1, wherein the tray holds the battery device such that the battery device is in an inclined state in which a handle of the tray faces obliquely upward.

6. The battery charging module according to claim 1, wherein the tray holds the battery device such that the battery device is in an upright state in which a handle of the tray faces upward.

7. A battery exchange device, wherein a plurality of battery charging modules for holding a battery device are attached to a support to form the battery exchange device,
wherein each of the battery charging modules is detachably attached to the support, and comprises a tray for guiding the battery device to a predetermined mounting position and holding the battery device at the mounting position,
wherein the tray comprises:
a wireless power transmitter for transmitting charging power to the battery device in a non-contact manner; and
a wireless communication device for transmitting and receiving battery management information to and from the battery device in a non-contact manner,
wherein either of the battery charging module or the support comprises:
a locking member for preventing the battery device from being removed from the mounting position, and a driver for driving the locking member; and
an indicator for indicating a state-of-charge of the battery device.

8. The battery exchange device according to claim 7, wherein the support comprises the locking member and the driver, for each battery charging module.

9. The battery exchange device according to claim 7, wherein the battery charging module is rotatably attached to the support so that the battery charging module is rotatable about an axis in a substantially vertical direction.

10. A battery device adapted to be held by the battery charging module according to claim 1, the battery device comprising a locking member for preventing the battery device from being removed from the mounting position, and a driver for driving the locking member.
